(19) United States
(12) Patent Application Publication
(10) Pub. No.: US 2024/0070680 A1
(43) Pub. Date: Feb. 29, 2024

(54) ARTIFICIAL INTELLIGENCE BASED SUSTAINABILITY SCORING AND CURATION OF RECOMMENDATIONS

(71) Applicant: Accenture Global Solutions Limited, Dublin (IE)

(72) Inventors: Paresh Vinay Takawale, Pune (IN); Anjali Haryani, Ujjain (IN); Tarun Patnaik, Bangalore (IN); Garima Mittal, Pune (IN); Mukul Dilip Patidar, Pune (IN); Yugandhar Anant Garde, Pune (IN)

(21) Appl. No.: 17/823,262

(22) Filed: Aug. 30, 2022

(51) Int. Cl. G06Q 30/00; G06Q 30/06

(52) U.S. Cl. CPC G06Q 30/018; G06Q 30/0631; G06Q 30/0633; G06Q 30/0627; G06Q 30/0629

(57) ABSTRACT

The present disclosure describes a system and method for applying machine learning to analyze the sustainability of products and using scoring based on the analysis to curate product recommendations for customers and feedback for product producers. The system and method incorporate product feature (e.g., sustainability) data, including historical data, from multiple sources, and user preferences to generate customized feature (e.g., sustainability) scores.

### TECHNICAL FIELD

The present disclosure generally relates to a system for identifying products having the highest level of sustainability. More specifically, the present disclosure generally relates to applying machine learning to generate sustainability scores and curate product recommendations based on the sustainability scores.

### BACKGROUND

Promoting a cleaner environment can be facilitated by providing consumers with more information about the products they purchase. While some such information is available, this information is often difficult to find, which means the consumer will not have the information at a convenient time, such as when they are moments from making a purchase. Additionally, information about the sustainability or other environmental factors of a product are based on speculation and predictions, rather than true experience, such as historical usage data. Finally, information about the sustainability or other environmental factors of a product often do not provide a full picture of the product's impact on the environment. For example, this information may not consider the overall emissions of a manufacturing company and delivery vendor.

There is a need in the art for a system and method that addresses the shortcomings discussed above.

### SUMMARY

The present disclosure describes a system and method for applying machine learning to analyze the sustainability of products and using scoring based on the analysis to curate product recommendations for customers and feedback for product producers. The system and method solve the problems discussed above by incorporating product feature (e.g., sustainability) data, including historical data, from multiple sources, and user preferences to generate customized feature (e.g., sustainability) scores.

In one aspect, the disclosure provides a computer-implemented method of generating sustainability scores and curating product recommendations based on the sustainability scores. The method may include receiving a user's product category selection. The method may include receiving user preferences related to sustainability attributes. The method may include in response to receiving the user's product category selection, retrieving sustainability metrics corresponding to a set of products categorized within the product category selection. The method may include inputting the user's product category selection and the retrieved sustainability metrics into a product sustainability score predictor. The method may include applying, by the product sustainability score predictor, machine learning to generate individual sustainability attribute scores for each product of the set of products based upon the inputted sustainability metrics, weighting the individual sustainability attribute scores based on the user's preferences, and combining the weighted individual sustainability attribute scores to generate a sustainability score for each product of the set of products. The method may include identifying a subset of products each having sustainability scores above a predetermined threshold, wherein the predetermined threshold is based at least in part on the user preferences. The method may include presenting, via a display of a user interface, the subset of products ranked in order of sustainability scores from highest to lowest.

In another aspect, the disclosure provides a non-transitory computer-readable medium storing software comprising instructions executable by one or more computers which, upon such execution, cause the one or more computers to: (1) receive a user's product category selection; (2) receive user preferences related to sustainability attributes; (3) in response to receiving the user's product category selection, retrieve sustainability metrics corresponding to a set of products categorized within the product category selection; (4) input the user's product category selection and the retrieved sustainability metrics into a product sustainability score predictor; (5) apply, by the product sustainability score predictor, machine learning to generate individual sustainability attribute scores for each product of the set of products based upon the inputted sustainability metrics, weight the individual sustainability attribute scores based on the user's preferences, and combine the weighted individual sustainability attribute scores to generate a sustainability score for each product of the set of products; (6) identify a subset of products each having sustainability scores above a predetermined threshold, wherein the predetermined threshold is based at least in part on the user preferences; and (7) present, via a display of a user interface, the subset of products ranked in order of sustainability scores from highest to lowest.

In another aspect, the disclosure provides a system for generating sustainability scores and curating product recommendations based on the sustainability scores, the system comprising one or more computers and one or more storage devices storing instructions that are operable, when executed by the one or more computers, to cause the one or more computers to: (1) receive a user's product category selection; (2) receive user preferences related to sustainability attributes; (3) in response to receiving the user's product category selection, retrieve sustainability metrics corresponding to a set of products categorized within the product category selection; (4) input the user's product category selection and the retrieved sustainability metrics into a product sustainability score predictor; (5) apply, by the product sustainability score predictor, machine learning to generate individual sustainability attribute scores for each product of the set of products based upon the inputted sustainability metrics, weight the individual sustainability attribute scores based on the user's preferences, and combine the weighted individual sustainability attribute scores to generate a sustainability score for each product of the set of products; (6) identify a subset of products each having sustainability scores above a predetermined threshold, wherein the predetermined threshold is based at least in part on the user preferences; and (7) present, via a display of a user interface, the subset of products ranked in order of sustainability scores from highest to lowest.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a display of a user interface presenting product recommendations to a user, according to an embodiment.

FIG. 2 is a schematic diagram of a display of a user interface presenting product recommendations to a user after a recommended product has been rejected, according to an embodiment.

FIG. 3 is a schematic diagram of a system for generating sustainability scores and curating product recommendations based on the sustainability scores, according to an embodiment.

FIG. 4 is a schematic diagram of the general flow of generating sustainability scores for products, in addition to recommending and curating a presentation of products to present to users, according to an embodiment.

FIG. 5 shows a Table 500 listing examples of product sustainable metrics, according to an embodiment.

FIG. 6 is a schematic diagram of the operations of building a product sustainability score predictor, according to an embodiment.

FIG. 7 is a schematic diagram of generating a product sustainability score, according to an embodiment.

FIG. 8 illustrates a computer-implemented method for generating sustainability scores and curating product recommendations based on the sustainability scores, according to an embodiment.

### DESCRIPTION OF EMBODIMENTS

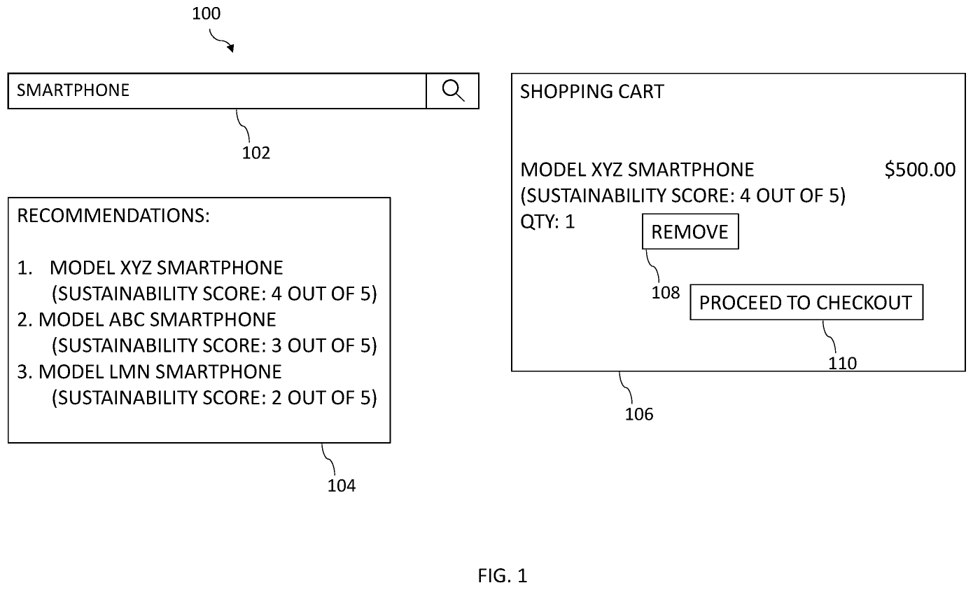

The disclosed system and method apply machine learning to evaluate features of products, as well as to curate a display of recommendations of products based on the evaluated features and user preferences related to the features, such that the recommendations are customized to the user preferences related to the features. While the examples discussed with reference to FIGS. 1-8 are related to embodiments in which the feature of the products is sustainability, it is understood that other features may be the focus of other embodiments.

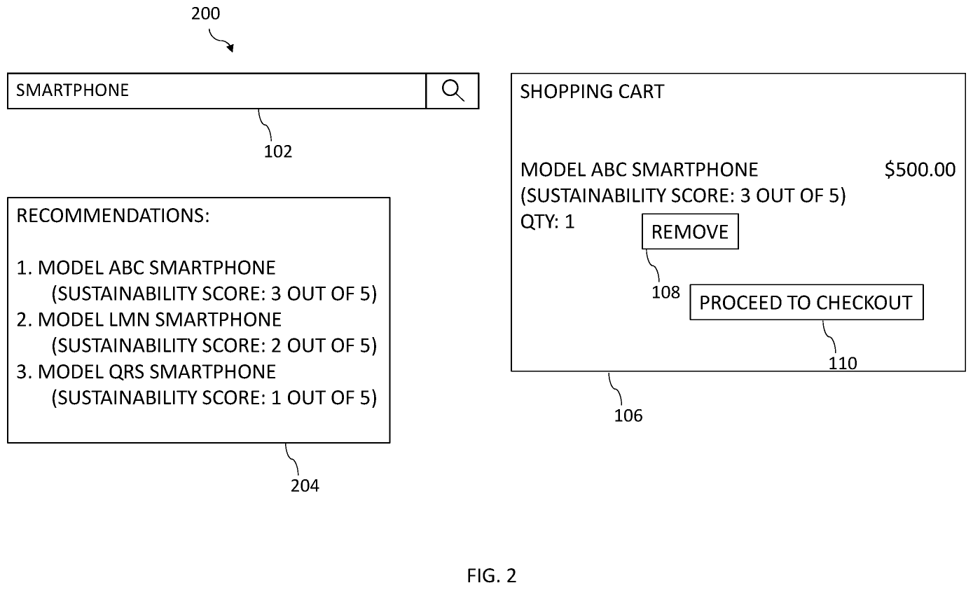

FIGS. 1 and 2 demonstrate how a recommendation may be presented to a user based on user input. The recommendations may be specially curated and dynamically change in response to user input. For example, the display presented to the user on a display of a user interface may dynamically change in response to the user's selection of product category and rejection of a recommended product. The display may additionally change in response to the user's preferences related to a particular feature (e.g., sustainability attributes).

FIG. 1 shows a recommendation 104 presented to a user on a display of a user interface, according to an embodiment. The user may select or input the product category of interest. For example, as shown in FIG. 1, the user may input “smartphone” into a search bar 102. It is understood that other modes of input may be used. For example, in other embodiments, a pulldown menu may list product categories for users to select from. Based on the product category selection, the disclosed system and method may generate sustainability scores for a set of products categorized in the selected product category. The system may identify a subset of products each having a sustainability score that is above a predetermined threshold based at least in part on user preferences. For example, the predetermined threshold may be based on user preferences related to sustainability attributes and a measure of sustainability calculated based on the sustainability metrics of each of the products of the set of products. Obtaining user preferences and calculating sustainability scores are discussed in more detail below. In response to identifying the subset of products, the system may automatically present, via a display of a user interface, the subset of products ranked in order of sustainability scores from highest to lowest. The subset of products may include a first set of recommendations for brands and/or models of products the user may be interested in. These recommendations may be displayed alongside sustainability scores that indicate the sustainability of the products. For example, as shown in FIG. 1, 3 recommendations are shown. These recommendations are shown in order of sustainability score value with the highest value first. Model XYZ Smartphone has a sustainability score of 4 out of 5. Model ABC Smartphone has a sustainability score of 3 out of 5. Model LMN Smartphone has a sustainability score of 2 out of 5. In some embodiments, the top recommendation may include the product having the highest sustainability score. The top recommendation may be automatically placed in a virtual shopping cart 106 (or checkout cart 106).

In some embodiments, the user may be presented with the option to reject recommendations. For example, as shown in FIG. 1, display 100 may include a remove button 108. The user may select remove button 108 to remove the top recommendation (e.g., Model XYZ Smartphone) from the virtual shopping cart. In other embodiments, a remove button may be provided next to individual recommendations in the listing of recommendations instead of or in addition to providing a remove button next to the item in the virtual shopping cart.

FIG. 2 shows display 200 after a user has removed Model XYZ Smartphone from virtual shopping cart 106. In the context of this document, the next best recommendation (or next best action) is a procedure where a “next best” option is presented upon rejection of a first best option. For example, if a user selects a product category that includes 5 products, and each of the 5 products has a different sustainability score from the others, initially, the product (of the 5 products) having the highest sustainability score can be presented to and/or recommended to the user first. For example, in some embodiments, a user interface may present the product with an indication that it is the recommended product. In another example, as shown in FIG. 1 and discussed above, the product may be automatically placed in a virtual shopping cart on a user interface. The user can simply select a proceed to checkout button 110 to proceed to checkout where a user may purchase the item by entering shipping and payment information, etc. Such a display feature provides the user with a quick and easy way to make a purchase based on their preferences with respect to sustainability. If the user indicates that they do not want to select the first recommended product (e.g., by selecting a button indicating “not interested” or by removing the product from the virtual shopping cart) the product having the next best sustainability score (compared with the first recommended product) will replace the product that was initially recommended on the user interface. For example, referring to FIGS. 1 and 2, if the user is presented with the display shown in FIG. 1 and selects remove button 108, Model XYZ Smartphone will be removed from virtual shopping cart and replaced by Model ABC Smartphone. The result can be presented to the user in a display (e.g., a display 200 shown in FIG. 2).

In the example of FIGS. 1 and 2, multiple products are listed. In response to removal of the top recommendation (i.e., Model XYZ Smartphone) from the virtual shopping cart, the top recommendation may also be automatically removed from the listing of products. In this example, to keep 3 products displayed, Model QRS Smartphone, the product having the next best sustainability score after Model LMN Smartphone, may be added to the displayed list of products. Model QRS Smartphone is shown with a sustainability score of 2 out of 5. While the exemplary embodiment in FIGS. 1 and 2 shows a listing of 3 recommendations, it is understood that another number of recommendations may be listed. For example, in some embodiments, only a single recommendation may be listed. In another example, 20 recommendations may be listed. The number of recommendations may be selected based on a variety of factors (e.g., the number of products available or the size of the display area).

If the user indicates that they do not want to select the second recommended product, then the product having the next best sustainability score (in comparison to the second recommended product) will replace the second product that was recommended on the user interface and so on. For example, the user may remove Model ABC Smartphone from the virtual shopping cart, and Model LMN Smartphone may replace Model ABC Smartphone in the virtual shopping cart. In response to removal from the virtual shopping cart, Model ABC Smartphone may additionally be automatically removed from the list presented to the user on the display and another product in the selected product category may be added to the listing.

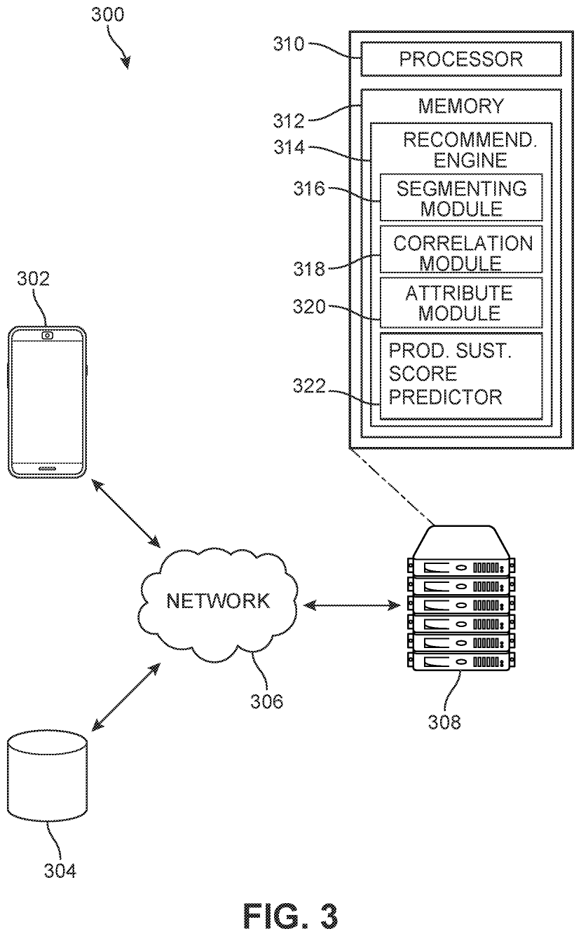

FIG. 3 is a schematic diagram of a system for generating sustainability scores and curating product recommendations based on the sustainability scores 300 (or system 300), according to an embodiment. The disclosed system may include a plurality of components capable of performing the disclosed computer implemented method of for generating sustainability scores and curating product recommendations based on the sustainability scores (e.g., method 800). For example, system 300 includes a user device 302, a computing system 308, a network 306, and a database 304.

The components of system 300 can communicate with each other through network 306. For example, user device 302 may access data from database 304 via network 1106. In some embodiments, network 306 may be a wide area network (“WAN”), e.g., the Internet. In other embodiments, network 306 may be a local area network (“LAN”). One or more resources of a virtual agent may be run on one or more servers. Each server may be a single computer, the partial computing resources of a single computer, a plurality of computers communicating with one another, or a network of remote servers (e.g., cloud). The one or more servers can house local databases and/or communicate with one or more external databases.

As shown in FIG. 3, a recommendation engine 314 may be hosted in computing system 308, which may have a memory 312 and a processor 310. Processor 310 may include a single device processor located on a single device, or it may include multiple device processors located on one or more physical devices. Memory 312 may include any type of storage, which may be physically located on one physical device, or on multiple physical devices. In some cases, computing system 308 may comprise one or more servers that are used to host recommendation engine 314. Recommendation engine 314 may include sentence segmenting module 316, correlation module 318, attribute module 320, and product sustainability score predictor 122. Database 304 may store data that may be retrieved by other components for system 300. For example, database 304 may store user preferences and/or sustainability metrics.

The user may include an individual using the disclosed system to obtain recommendations. While FIG. 3 shows a single user device, it is understood that more user devices may be used. For example, in some embodiments, the system for generating sustainability scores and curating product recommendations based on the sustainability scores may include two or three user devices. The user device may be a computing device used by a user for communicating with the system. In some embodiments, one or more of the user devices may include a smartphone or a tablet computer. In other embodiments, one or more of the user devices may include a laptop computer, a desktop computer, and/or another type of computing device. The user devices may be used for inputting, processing, and displaying information. The user device may include a display that provides an interface for the user to input and/or view information.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

Embodiments may also include one or more computers and one or more storage devices storing instructions that are operable, when executed by the one or more computers, to cause the one or more computers to perform the disclosed methods.

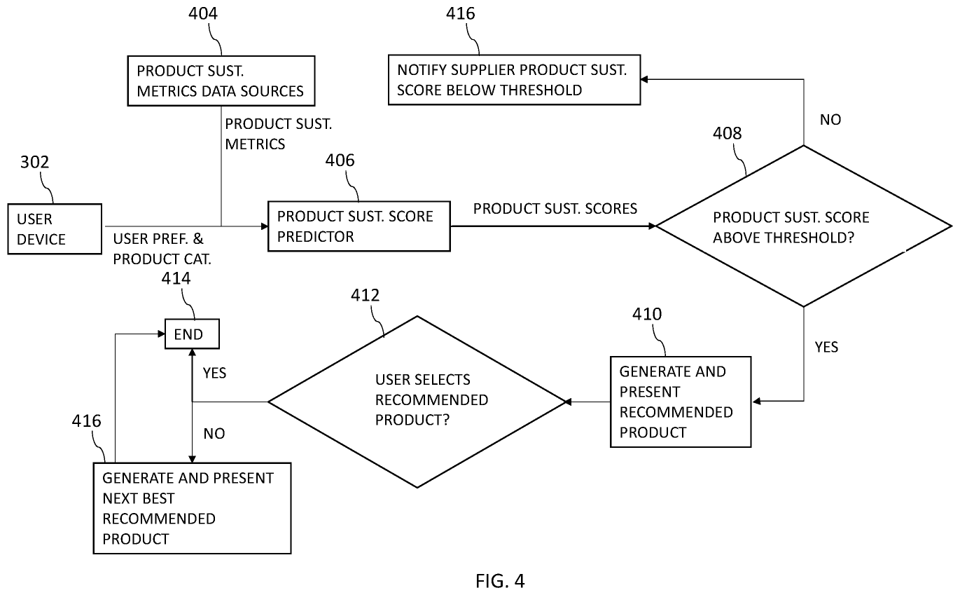

While FIGS. 1 and 2 focus on the curation of recommended products, FIG. 4 shows the general flow of generating sustainability scores for products, in addition to recommending and curating a presentation of products to present to users (e.g., customers), according to an embodiment. As discussed with reference to FIG. 1, a user may interact with a user interface (e.g., user device 302) to select or input a product category the user is interested in. The user may also input their preferences with respect to a feature attributes (e.g., sustainability). For example, in some embodiments, the user may be presented with a selection of sustainability attributes from which the user may choose. The user may input their sustainability preferences for products by selecting sustainability attributes that they would like to prioritize. For example, the user may be presented with a listing of sustainability attributes on the interface of user device 302 and may click boxes or radio buttons to select sustainability attributes. Nonlimiting examples of sustainability attributes may include whether a product is bio-degradable, recyclable, locally manufactured, and renewable/non renewable energy sources. Nonlimiting examples of sustainability attributes may further include the amount of energy used in manufacturing, the waste footprint, the water footprint, the downstream distribution distance, the percentage of hazardous material as input, and hazardous material byproduct while manufacturing. In some embodiments, the user may select the sustainability attributes one time to be applied to all product categories. In other embodiments, the user may select sustainability attributes for each product category separately. For example, the user may select only waste footprint for televisions, but may select recyclability and bio-degradable for headphones.

In some embodiments, the user may bypass selecting their preferences related to sustainability attributes. In such embodiments, the user's past purchase history may substitute for their selected preferences related to sustainability attributes. The user's past purchase history can be automatically analyzed to extract which sustainability attributes the user tends to prioritize in their product selection. In some embodiments, this extraction may be specific to particular product categories. In other embodiments, this extraction may be applied to all product categories.

In response to receiving a user's product category selection, the disclosed computer-implemented method may include automatically obtaining or collecting product sustainability metrics (or other metrics related to features of interest) from product sustainability metrics data sources 404. For example, the disclosed method may include automatically retrieving sustainability metrics from product sustainability metrics data sources. The sustainability metrics data sources may include various sources. In some embodiments, one source may be a supplier/manufacturer (e.g., vehicle manufacturer, generator supplier, smartphone manufacturer etc.). The sustainable metrics from suppliers and/or manufacturers typically include metrics related to: the raw materials used to make products, the design size/weight of a product, the location in which products are manufactured, etc. These sustainable metrics from suppliers and/or manufacturers may also include predicted metrics that are based on calculations or speculation. For example, predicted metrics may include upstream procurement cost, product life span, total waste footprint, etc.

Another source may additionally include an agency, such as the Environmental Protection Agency (EPA) and its affiliates. The sustainability metrics collected, according to embodiments, are holistic in that these metrics correspond to every different phase of a product, including each stage of product lifecycle including design, manufacturing, consumption, disposal, and decomposition, which helps the consumer to select the greenest possible product not only based on emissions at the manufacturing stage but also the emissions for consumption and disposal stage. Providing this information gives a more complete picture of the product's impact on the environment. Additionally, the agency metrics may include actual values/attributes of products based on real life use versus calculations or speculation. In other words, the agency data is historical data providing actual metrics. In some embodiments, the sustainability metrics data distributed by agencies may be loaded onto database 304 at specific intervals to keep the sustainability metrics data available to the system up-to-date.

In some embodiments, the emissions data provided in the sustainability metrics may include one or more of Scope 1, 2, and 3 data. Scope 1 data include direct emissions from sources owned or directly controlled by an entity (e.g., manufacturer or supplier). Scope 2 data include indirect emissions from the generation of purchased electricity, steam, and/or heating and cooling consumed by an entity. Scope 3 data includes emissions that are the result of an entity's actions but occur from sources not owned or controlled by the entity.

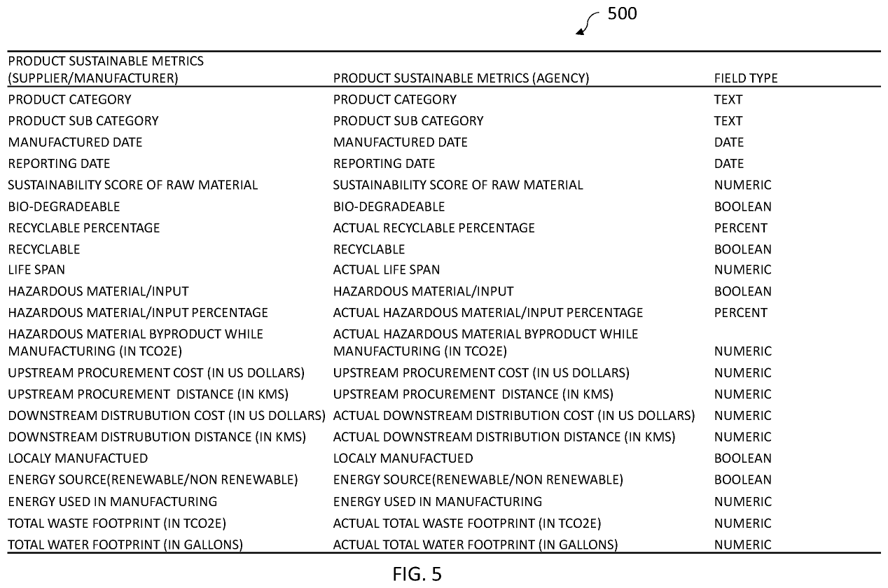

FIG. 5 shows a Table 500 listing examples of product sustainable metrics provided by a supplier and/or manufacturer and corresponding product sustainable metrics provided by an agency, as well as corresponding field types, according to an embodiment. As one can see by comparing the metrics side-by-side along a row of the table, some of the metrics may be the same. For example, the product category metric may be the same for the supplier/manufacturer and the agency. For this particular metric, the field may include text. For example, the product category may be a name of a product category, such as, “vehicle,” “computer”, “smart phone”, “television”, etc. While some metrics may be the same, other metrics may be different. For example, the metrics provided by a supplier/manufacturer may be based on predictions and/or calculations based on assumptions. However, the metrics provided by the agency may be based on real life data based on historical experiences. For example, the supplier/manufacturer may include a predicted life span while the agency may provide an “actual” life span based on what actually happened to products in real life use. More specifically, in one example, the predicted life span may be 5 years, but the actual life span in real life use turns out to be 3 years.

In another example, the supplier/manufacturer may include a predicted hazardous material/input percentage while the agency may provide an “actual” hazardous material/input percentage based on what actually happened to products in real life use.

The product sustainable metrics may include various fields. For example, Table 500 shows the fields of percent, numeric, Boolean, and date in the far right column. In the example of Table 500, the field type for hazardous material/input percentage may be percent. The field type for life span may be numeric (e.g., number of days, months, years, or other unit of time). The field type for locally manufactured may be Boolean, as whether or not a product is locally manufactured is a true/false question. The field type for manufactured date may be a date.

The user input of product category may be input into a product sustainability score predictor 406. User preferences may additionally be input into product sustainability score predictor 406. As discussed above, in some cases, the user preferences may be explicit preferences the user has selected. In other cases, the user preferences may be extracted from past purchase history of the user. Product sustainability score predictor 406 may further receive product sustainability metrics from product sustainability metrics data sources 404. In response to receiving the inputs, product sustainability score predictor 406 may automatically apply machine learning to the inputs to generate a product specific sustainability score that indicates the sustainability of the product, as well as the user's specific preferences with respect to sustainability. While sustainability is the focus of this description of product sustainability score predictor 406, it is understood that other embodiments may include a score predictor that focuses on other features, such as comfort or design style. The details of building and training product sustainability score predictor 406, as well as how product sustainability score predictor 406 predicts scores is discussed in more detail below.

In response to generating a product sustainability score, the disclosed computer-implemented method may include a decision point 408 in which the predicted score is compared to a predetermined threshold that is customized to match user preferences. This decision point may be used for reinforcement learning, whereby a manufacturer or supplier responsible for manufacturing and/or selling the product learns of feedback from the disclosed system and uses the feedback to improve their product. If the predicted score for a product is below the predetermined threshold, this feedback is provided to a manufacturer or supplier responsible for manufacturing and/or selling the product at operation 416. The manufacturer or supplier can use this feedback to adjust the product (e.g., through redesign) to improve sustainability attributes. For example, in some embodiments, the analysis performed by product sustainability score predictor 406 may be deconstructed to identify which factors contributed to the score. These factors may include the sustainability metrics of the product as well as the user preferences. By knowing this information, a manufacturer or supplier can understand which aspects of the product should be improved to improve (i.e., raise) the product's sustainability score, thereby improving the product's popularity and improving the product's impact on the environment. In turn, various industries may collectively improve their impact on the environment.

In addition to a manufacturer or supplier responsible for manufacturing and/or selling the product basing improvements on user feedback extracted by the system, the product sustainability score predictor may also apply reinforcement learning by improving its own processes of generating sustainability scores based on user feedback extracted by the system.

If the predicted score is above the predetermined threshold, the product may be included in a product recommendation generated and presented to a user at operation 410. For example, referring back to FIGS. 1 and 2, the product may be included as one of the 3 recommendations presented to the user. At another decision point 412, a user may select a recommended product. For example, if the recommended product is in the virtual checkout cart, the user may select the checkout button. Selecting the recommended product may also include removing products from the recommendation listing or the checkout box until the desired product is remaining in the listing and/or the virtual checkout cart. If the user selects the recommended product, the process may end at operation 414 upon the user purchasing the product. However, if the user does not select the recommended product, then the next best product is generated and presented at operation 416. In some embodiments, this operation can be performed in the manner discussed above with respect to FIGS. 1 and 2. As previously mentioned, the user's rejection or selection of the recommended product can drive the path of the generation and presentation of recommended products. If a user continues to reject recommended products, the next best recommended product will be generated and presented. However, if a user selects (e.g., purchases) a recommended product, then the cycle will end at operation 414.

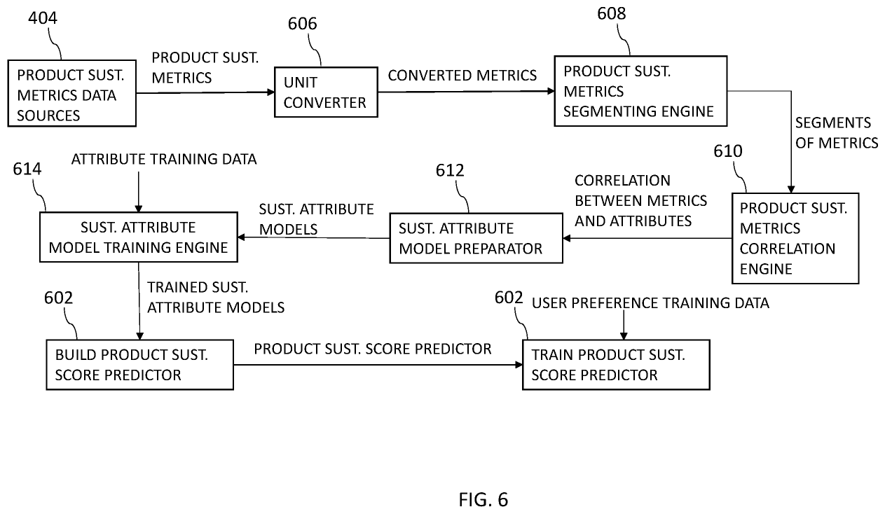

FIG. 6 shows the operations of building a product sustainability score predictor, according to an embodiment. In some embodiments, product sustainability metrics may be collected from product sustainability metrics data sources 404. As the product sustainability metrics may be collected in various units of measurements for the same attributes, the method may include applying a unit converter 606 to convert the product sustainability metrics to common units of measurement for each sustainability metric. For example, the product sustainability metric of water used at all stages of a product could be provided in gallons in some cases and liters in other cases. Nevertheless, the disclosed system can compensate for these disparate units by converting the units to the same unit (e.g., centum cubic feet (CCF)) before calculating a sustainability score. Other examples of units of measurement for various sustainability metrics include metric tons of carbon dioxide equivalent (MTCO2e), kilometers (km), cubic meter per square foot etc. While converting the product sustainability metrics to similar units of measurement is shown as occurring before segmenting the product sustainability metrics, it is understood that this operation may occur at other points in the process of generating product sustainability scores.

In some embodiments, a product sustainability metrics segmenting engine 608 may segment the product sustainability metrics by applying unsupervised learning to cluster the product sustainability metrics into segments based on similarity. For example, the product sustainability metrics may be segmented into Scope 1, 2, or 3 data and/or the product type to which the data pertains. Product sustainability metrics segmenting engine 608 may cluster the product sustainability metrics before or after the product sustainability metrics are converted into common units. In some embodiments, the product sustainability metrics may already be in common units and may not need to be converted. In such embodiments, the unit converter may be bypassed or even simply omitted from the system.

In some embodiments, the method may include segmenting the collected data by applying unsupervised learning, such as, for example, clustering. Nonlimiting examples of clustering include k-means clustering or density based clustering. The collected data may be converted into vectors (or data points) that are plotted in a multidimensional space and the vectors may be clustered according to proximity to one another. Each cluster (or segment) may be identified based on the common/unifying attribute of the clustered data points. For example, in some embodiments, the data (i.e., sustainability metrics) may be clustered to identify clusters belonging to segments, such as, Scope 1, 2, or 3 data and/or the product type to which the data pertains. Clustering the data into segments cleans the data and makes the data ready for use as input to the sustainability attribute models.

In some embodiments, a product sustainability metrics correlation engine 610 may analyze the segmented data output by product sustainability metrics segmenting engine 608 to determine which product sustainability metrics are correlated (i.e., have relationships with one another). For example, this analysis may determine whether product life span is related to (e.g., dependent on) carbon emissions, waste, or water. The relationships between product sustainability metrics may be assessed and applied to build sustainability attribute models, as discussed next, and also to map the product sustainability metrics to the sustainability attribute models after they models are built.

In some embodiments, a sustainability attribute model preparator 612 can prepare (or build) a plurality of sustainability attribute models each specific to a different sustainability attribute. For example, one model can be prepared for carbon emissions, another model for water, and yet another model for waste. The models can be prepared based on the clustered product sustainability metrics' relationship to sustainability attributes. In other words, product sustainability metrics correlation engine can analyze the data in each segment (e.g., Scope 1 data) for its behavior and/or the outcome resulting from the sustainability metrics in a particular segment. The results of this analysis can be applied to prepare (or build) a plurality of sustainability attribute models each specific to a different sustainability attribute.

Once all data is collected, segmented, and identified (or classified), a sustainability attribute model training engine 614 may train sustainability attribute models to use the sustainability metrics of a product as input to generate (or calculate) sustainability scores. In some embodiments, supervised machine learning may be applied to train the plurality of sustainability attribute models. Since each sustainability attribute model is specific to a particular sustainability attribute, the sustainability metrics corresponding to the sustainability attribute may be used to train the model corresponding to the sustainability attribute. For example, a sustainability attribute model may be specific to the sustainability attribute of waste. Accordingly, this model can be trained by applying product sustainability metrics related to waste. After training, the model specific to waste can take a product as input and calculate a sustainability score specific to waste. In this way, when a product is input into multiple sustainability attribute models each specific to a different sustainability attribute, multiple sustainability scores can be generated for the same product. These scores may each reflect the sustainability of the input product with respect to each of the attributes corresponding to the sustainability attribute models. It is understood that in applications other than sustainability of products, such as automobiles, telecom, financial services, may be analyzed by the disclosed methods in other embodiments. In such embodiments, attributes other than those related to sustainability may be provided as the input metrics for building attribute models and may be analyzed by the attribute models to help generate a score related to a feature other than sustainability. For example, furniture may be analyzed based on attributes related to comfort to generate a score indicating the level of comfort provided by the furniture. In another example, home locations may be analyzed based on attributes related to family friendly neighborhoods to generate a score indicating how family friendly the neighborhood surrounding the home is. The output of each of the plurality of sustainability attribute models may be used as input by the product sustainability score predictor to generate sustainability scores for products.

The disclosed method may include building a product sustainability score predictor. After building and training the individual sustainability attribute models, the trained sustainability attribute models may be used as components of the product sustainability score predictor. The product sustainability score predictor may generate product sustainability score based on the sustainability scores for each of the sustainability attributes related to a product. For example, in some embodiments, a product sustainability score for a product (e.g., television) may be based on the output of each of the sustainability attribute models for the product (e.g., carbon emissions, water, waste, life span, etc.). To account for a user's preferences related to sustainability, the product sustainability score predictor can be trained to weigh each of the attribute scores for the product according to user preferences. In some embodiments, the user preferences may be provided in the form of explicitly selected user preferences. In some embodiments, the user preferences may be provided additionally or alternatively in the form of historical user purchase information. For example, if a user selects life span as a metric that they prioritize, then the output from an attribute model for life span can be given more weight by the product sustainability score predictor. In some embodiments, the product sustainability score predictor may be a machine learning model. In some embodiments, the product sustainability score predictor may be trained by applying supervised learning.

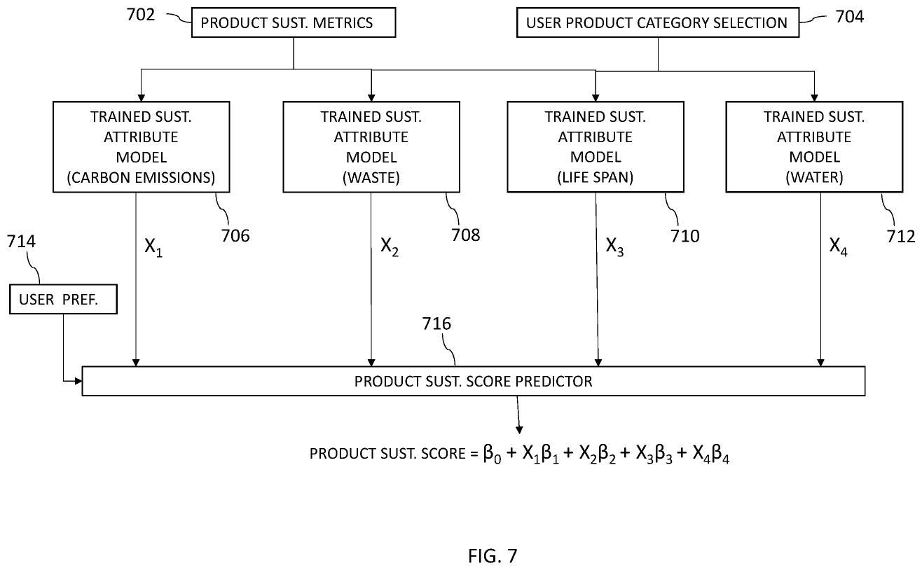

FIG. 7 further illustrates how a product sustainability score predictor can generate a product sustainability score, according to an embodiment. FIG. 7 shows an example in which multiple attribute models have been built and trained according to the operations discussed with respect to FIG. 6. In this example, scoring is based upon the attributes of carbon emissions, waste, life span, and water. In other words, product sustainability score predictor 716 incorporates individual trained sustainability attribute models to generate sustainability attribute scores corresponding to the attributes the models are each based on. For example, trained sustainability attribute model 706 may generate a sustainability attribute score based on carbon emissions; trained sustainability attribute model 708 generate a sustainability attribute score based on waste; trained sustainability attribute model 710 may generate a sustainability attribute score based on life span; and trained sustainability attribute model 712 may generate a sustainability attribute score based on water. A user product category selection 704 and product sustainability metrics 702 corresponding to a product categorized in the selected product category may be input to the sustainability attribute models. The output of trained sustainability attribute model 706 may include X₁. The output of trained sustainability attribute model 708 may include X₂. The output of trained sustainability attribute model 710 may include X₃. The output of trained sustainability attribute model 712 may include X₄. User preferences 714 (e.g., explicitly selected user preferences or user preferences extracted from user purchase history) may be input into product sustainability score predictor to determine weights to apply to the output of the sustainability attribute models. In some embodiments, the output generated by the product sustainability score predictor may include a score generated by the following equation:

PRODUCT SUST. SCORE=β₀+X₁⊕₁+X₂β₂+X₃β₃+X₄β₄ [Equation 1].

In Equation 1, β₀, β₁, β₂, β₃, and β₄ depend upon user preferences. In other words, β₀, β₁, β₂, β₃, and β₄ may each be applied to weight sustainability attributes according to user preferences corresponding to each of the sustainability attributes. While this example discusses only 4 attributes, it is understood that other embodiments may include different numbers of attributes and corresponding trained sustainability attribute models. For example, another embodiment may include trained sustainability attribute models corresponding to each attribute appearing in FIG. 5. In another embodiment, only the trained sustainability attribute models corresponding to attributes selected by the user as the user preferences may be applied by the product sustainability score predictor.

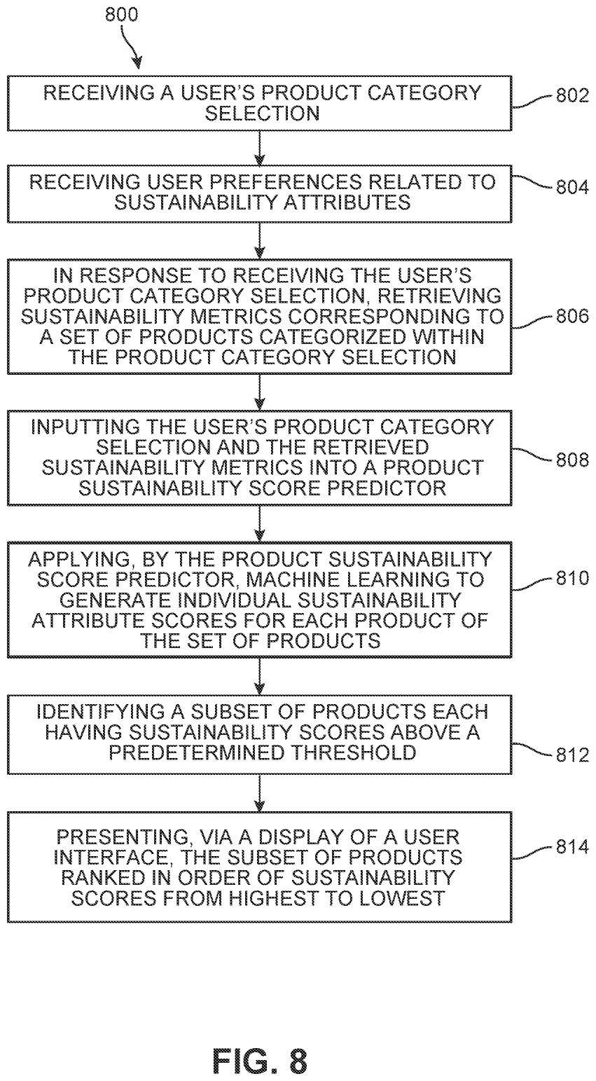

FIG. 8 illustrates a computer-implemented method for generating sustainability scores and curating product recommendations based on the sustainability scores 800 (or method 800), according to an embodiment. Method 800 may include receiving a user's product category selection (operation 802). For example, as discussed with respect to FIGS. 1 and 2, a user may enter a product category selection into a search bar of a display. Method 800 may include receiving user preferences related to sustainability attributes (operation 804). Method 800 may include in response to receiving the user's product category selection, retrieving sustainability metrics corresponding to a set of products categorized within the product category selection (operation 806). Method 800 may include inputting the user's product category selection and the retrieved sustainability metrics into a product sustainability score predictor (operation 808). Method 800 may include applying, by the product sustainability score predictor, machine learning to generate individual sustainability attribute scores for each product of the set of products based upon the inputted sustainability metrics, weighting the individual sustainability attribute scores based on the user's preferences, and combining the weighted individual sustainability attribute scores to generate a sustainability score for each product of the set of products (operation 810). Method 800 may include identifying a subset of products each having sustainability scores above a predetermined threshold, wherein the predetermined threshold is based at least in part on the user preferences (operation 812). Method 800 may include presenting, via a display of a user interface, the subset of products ranked in order of sustainability scores from highest to lowest (operation 814).

In some embodiments, the method may include, in response to the sustainability score of a product falling below the predetermined threshold, communicating the sustainability score of the product to a supplier and/or manufacturer of a respective product.

In some embodiments, the method may include identifying and placing a highest ranked product of the subset of products in a virtual checkout cart.

In some embodiments, the method may include, in response to a user rejecting the highest ranked product of the subset of products, placing a second highest ranked product of the subset of products in the virtual checkout cart in place of the highest ranked product.

In some embodiments, the method may include, in response to a user rejecting a highest ranked product of the subset of products, presenting, via the display of the user interface, a second highest ranked product of the subset of products in place of the highest ranked product.

In some embodiments, the method may include training the product sustainability score predictor based on training data including user preference data and sustainability metric data.

In some embodiments, the method may include applying unsupervised machine learning to segment the training data, including sustainability metric data, into segments.

In some embodiments, the method may include the user preferences being explicitly selected by the user.

Throughout this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls.

Software instructions may be read into memory and/or storage components from another computer-readable medium or from another device via communication interface. When executed, software instructions stored in memory and/or storage component may cause processor to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

In some implementations, a policy management service may be hosted in a cloud computing environment. Notably, while implementations described herein describe a policy management service as being hosted in cloud computing environment, in some implementations, a policy management service may not be cloud-based (i.e., may be implemented outside of a cloud computing environment) or may be partially cloud-based.

Cloud computing environment can include, for example, an environment that hosts the policy management service. The cloud computing environment may provide computation, software, data access, storage, etc. services that do not require end-user knowledge of a physical location and configuration of system(s) and/or device(s) that hosts the policy management service. For example, a cloud computing environment may include a group of computing resources (referred to collectively as “computing resources” and individually as “computing resource”).

While various embodiments are described, the description is intended to be exemplary, rather than limiting and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

We claim:

1. A computer-implemented method for generating sustainability scores and curating product recommendations based on the sustainability scores, the method comprising:
receiving a user's product category selection;
receiving user preferences related to sustainability attributes;
in response to receiving the user's product category selection, retrieving sustainability metrics corresponding to a set of products categorized within the product category selection;
inputting the user's product category selection and the retrieved sustainability metrics into a product sustainability score predictor;
applying, by the product sustainability score predictor, machine learning to generate individual sustainability attribute scores for each product of the set of products based upon the inputted sustainability metrics, weighting the individual sustainability attribute scores based on the user's preferences, and combining the weighted individual sustainability attribute scores to generate a sustainability score for each product of the set of products;
identifying a subset of products each having sustainability scores above a predetermined threshold, wherein the predetermined threshold is based at least in part on the user preferences; and
presenting, via a display of a user interface, the subset of products ranked in order of sustainability scores from highest to lowest.

2. The method of claim 1, further comprising:
in response to the sustainability score of a product falling below the predetermined threshold, communicating the sustainability score of the product to a supplier and/or manufacturer of a respective product.

3. The method of claim 1, further comprising:
identifying and placing a highest ranked product of the subset of products in a virtual checkout cart.

4. The method of claim 3, further comprising:
in response to a user rejecting the highest ranked product of the subset of products, placing a second highest ranked product of the subset of products in the virtual checkout cart in place of the highest ranked product.

5. The method of claim 1, further comprising:
in response to a user rejecting a highest ranked product of the subset of products, presenting, via the display of the user interface, a second highest ranked product of the subset of products in place of the highest ranked product.

6. The method of claim 1, further comprising:
training the product sustainability score predictor based on training data including user preference data and sustainability metric data.

7. The method of claim 6, further comprising:
applying unsupervised machine learning to segment the training data, including sustainability metric data, into segments.

8. A non-transitory computer-readable medium storing software comprising instructions executable by one or more computers which, upon such execution, cause the one or more computers to:
receive a user's product category selection;
receive user preferences related to sustainability attributes;
in response to receiving the user's product category selection, retrieve sustainability metrics corresponding to a set of products categorized within the product category selection;
input the user's product category selection and the retrieved sustainability metrics into a product sustainability score predictor;
apply, by the product sustainability score predictor, machine learning to generate individual sustainability attribute scores for each product of the set of products based upon the inputted sustainability metrics, weight the individual sustainability attribute scores based on the user's preferences, and combine the weighted individual sustainability attribute scores to generate a sustainability score for each product of the set of products;
identify a subset of products each having sustainability scores above a predetermined threshold, wherein the predetermined threshold is based at least in part on the user preferences; and
present, via a display of a user interface, the subset of products ranked in order of sustainability scores from highest to lowest.

9. The non-transitory computer-readable medium storing software of claim 8, wherein the instructions further cause the one or more computers to:
in response to the sustainability score of a product falling below the predetermined threshold, communicate the sustainability score of the product to a supplier and/or manufacturer of a respective product.

10. The non-transitory computer-readable medium storing software of claim 8, wherein the instructions further cause the one or more computers to:
identify and place a highest ranked product of the subset of products in a virtual checkout cart.

11. The non-transitory computer-readable medium storing software of claim 8, wherein the instructions further cause the one or more computers to:
in response to a user rejecting a highest ranked product of the subset of products, place a second highest ranked product of the subset of products in a virtual checkout cart in place of the highest ranked product.

12. The non-transitory computer-readable medium storing software of claim 8, wherein the instructions further cause the one or more computers to:
in response to a user rejecting a highest ranked product of the subset of products, present, via the display of the user interface, a second highest ranked product of the subset of products in place of the highest ranked product.

13. The non-transitory computer-readable medium storing software of claim 8, wherein the instructions further cause the one or more computers to:
train the product sustainability score predictor based on training data including user preference data and sustainability metric data.

14. The non-transitory computer-readable medium storing software of claim 13, wherein the instructions further cause the one or more computers to:
apply unsupervised machine learning to segment the training data, including sustainability metric data, into segments.

15. A system for generating sustainability scores and curating product recommendations based on the sustainability scores, the system comprising one or more computers and one or more storage devices storing instructions that are operable, when executed by the one or more computers, to cause the one or more computers to:
receive a user's product category selection;
receive user preferences related to sustainability attributes;
in response to receiving the user's product category selection, retrieve sustainability metrics corresponding to a set of products categorized within the product category selection;
input the user's product category selection and the retrieved sustainability metrics into a product sustainability score predictor;
apply, by the product sustainability score predictor, machine learning to generate individual sustainability attribute scores for each product of the set of products based upon the inputted sustainability metrics, weight the individual sustainability attribute scores based on the user's preferences, and combine the weighted individual sustainability attribute scores to generate a sustainability score for each product of the set of products;
identify a subset of products each having sustainability scores above a predetermined threshold, wherein the predetermined threshold is based at least in part on the user preferences; and
present, via a display of a user interface, the subset of products ranked in order of sustainability scores from highest to lowest.

16. The system of claim 15, wherein the instructions further cause the one or more computers to:
in response to the sustainability score of a product falling below the predetermined threshold, communicate the sustainability score of the product to a supplier and/or manufacturer of a respective product.

17. The system of claim 15, wherein the instructions further cause the one or more computers to:
identify and place a highest ranked product of the subset of products in a virtual checkout cart.

18. The system of claim 15, wherein the instructions further cause the one or more computers to:
in response to a user rejecting a highest ranked product of the subset of products, place a second highest ranked product of the subset of products in a virtual checkout cart in place of the highest ranked product.

19. The system of claim 15, wherein the instructions further cause the one or more computers to:
in response to a user rejecting a highest ranked product of the subset of products, present, via the display of the user interface, a second highest ranked product of the subset of products in place of the highest ranked product.

20. The system of claim 19, wherein the user preferences being explicitly selected by the user.
